(19) United States
(12) Patent Application Publication
(10) Pub. No.: US 2025/0015627 A1
(43) Pub. Date: Jan. 9, 2025

(54) CLOSED LOOP ZERO-EMISSION ELECTRIC POWER GENERATION

(71) Applicant: Michael C. Elder, Peachtree City, GA (US)

(72) Inventor: Michael C. Elder, Peachtree City, GA (US)

(21) Appl. No.: 18/761,765

(22) Filed: Jul. 2, 2024

Related U.S. Application Data
(60) Provisional application No. 63/511,857, filed on Jul. 3, 2023.

(51) Int. Cl. H02J 7/14; H02J 7/00; H02K 53/00

(52) U.S. Cl. CPC H02J 7/1423; H02J 7/00309; H02J 7/0031; H02J 7/143; H02J 7/1492; H02K 53/00

(57) ABSTRACT

A system and method for generating clean energy. The system includes one or more alternators for generating electricity and a motor for driving one or more alternators. The system also includes a first battery set and a second battery set, wherein each of the first battery set and the second battery set are configured to power the motor. A switching unit is used to switch each of the first battery set and the second battery set between an active state and an offline state. The respective battery set in the active state powers the motor, and the respective battery set in the offline state is charged by the switching unit using electricity generated from one or more alternators.

### CROSS-REFERENCE TO RELATED APPLICATIONS

This application claims priority from a U.S. Provisional Patent Appl. No. 63/511,857, filed on Jul. 3, 2023, which is incorporated herein by reference in its entirety.

### FIELD OF INVENTION

The present invention relates to electric power generation, and more particularly, the present invention relates to clean energy generation.

### BACKGROUND

Electricity is a lifeline of the modern world; however, a major portion of electricity is generated through fossil fuels. Burning of fossil fuels results in the emission of greenhouse gases in large amounts. Global warming due to greenhouse gases has significantly increased in the last few decades and has become a global climatic problem. Because of this, countries worldwide are now switching from fossil fuels to clean energy sources.

Also, known as renewable energy sources, the primary sources of clean energy include the sun, wind, and waves. Solar energy has the biggest share in present electricity generation from renewable sources. However, the known renewable energy sources have a major limitation in that they are not available all the time. Thus, an industrial need is there to explore more clean energy sources.

### SUMMARY OF THE INVENTION

The following presents a simplified summary of one or more embodiments of the present invention to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a closed-loop system for generating clean energy without the need for renewable energy sources.

Still, another object of the present invention is that the system has zero emissions.

A further object of the present invention is that the system is dependable.

Yet another object of the present invention is that the system is easy to install and use.

A further object of the present invention is that energy can be generated day and night independently of the environment.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a block diagram showing the architecture of the disclosed system, according to an exemplary embodiment of the present invention.

FIG. 2 shows an implementation of the system, according to an exemplary embodiment of the present invention.

FIG. 3 shows a cooling unit of the system, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

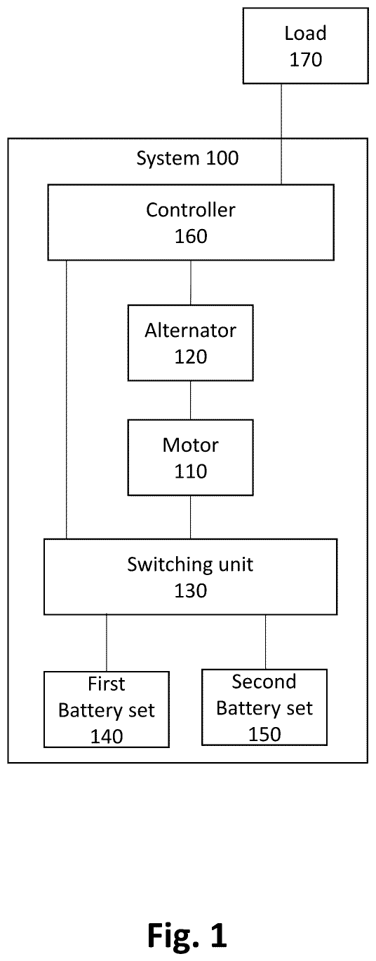

Disclosed are a system and method for generating clean energy i.e., generating electricity without carbon emissions and without depending on nature. The disclosed system includes one or more motors, one or more alternators, a switching unit, a first set of batteries, a second set of batteries, and a cooling unit. Referring to FIG. 1 is a block diagram showing the architecture of the disclosed system. System 100 includes a motor 110, an alternator 120, a switching unit 130, a first battery set 140, a second battery set 150, and a controller 160. The motor can be a DC motor that can run on batteries. However, any type of motor that can be run on batteries and could drive one or more alternators is within the scope of the present invention. Preferably, a low-noise motor with high energy efficiency is preferable, according to the present invention. Moreover, the capacity of the motor can be such that it can drive two or more alternators at one time. Moreover, it may be preferable that a single motor can drive three or more alternators. It may be desirable that the single motor can drive four or more alternators, as it may be more energy efficient.

In certain implementations, the alternator can be an earth magnet frameless alternator. The construction and design of such alternators are known in art. Although frameless earth magnet alternators may be preferred, any alternator can be used without departing from the scope of the present invention. One or more alternators can be driven by a motor to generate electricity.

One or more motors can be driven by batteries. The system includes a first battery set and a second battery set. Each battery set can drive one or more motors of the system. Each battery set can include one or more battery units or cells. The two battery sets are rechargeable battery sets that can be charged by the current output of the system. It is to be noted that the drawings show two battery sets, however, more than two battery sets are within the scope of the present invention. The disclosed system can be used in different types of electrical systems, such as domestic appliances, industrial machines, drones, aircraft, water vessels, road vehicles, and the like. Depending upon the electricity capacity needed, multiple independent batteries can be used. Thus, any number of batteries, type of batteries, and batteries of different capacities are within the scope of the present invention. Also, in each set, there could be more units that can be used in rotation. For example, to allow the battery to cool after being in active state or charged. Also, based on demand, spare units can be utilized, for example, for use in heavy machines. This, the switching unit may also allow switching the battery units in any order, also referred to herein as rotation of the battery units within a battery set.

The switching unit can switch the two battery sets between an active state and an offline state. The battery set in the active state can be connected to a load i.e., drive the motor according to the present invention. The battery set in the offline state can be disconnected from the load and can be charged. Each of the two battery sets can be in one of the two states. The switching unit can continuously detect the charge status of the two battery sets. When the battery set in the active state has a charge level below a predefined threshold, the switching unit can switch the battery set from the active state to the offline state. When switched to the offline state, the battery set is connected to charging circuitry for charging the battery set. At the same time, the battery set that was in the offline state and was being charged can be removed from the charging circuitry, and connected to the motor, thus changing the state to active from offline. The switching can be instant thus preventing any interruptions in the operation of the motor. The switching unit includes the charging circuitry for charging the battery sets. The switching unit can get a charging line from the output of the system for charging the battery. The output of the system can be connected to an external load and the switching unit for charging the battery. The load can be any electrical device that is powered by electricity and may include domestic appliances, industrial machines, electrical vehicles, and the like. The output of the system may also be connected to an electrical grid.

The system may include housing that encases different components of the system. The interior of the housing can be cooled using the cooling unit. The cooling unit can be based on refrigeration technology, or any suitable technology known in the art. The interior of the housing and thus the enclosed components can be kept cooled to the desired temperature. The desired temperature can be any temperature that prevents energy loss and enhances the efficiency of the system.

The housing can also be made from heat-resistant material that insulates the interior enhancing the cooling efficiency. Moreover, the housing can be made soundproof, preventing any noise.

A controller 160 can control the output current from the alternator. As shown in the drawing, the current from the controller can be supplied to load 170. Also, one conductor connects the controller to the switching unit for charging the battery set.

In certain implementations, the switching unit may include a geared switching mechanism for switching between battery sets. Every product being powered, unless specified, can have a unique set of metrics based on voltage and amps per the offline recharging time frame before it is set to be active again for active use. With voltage and amps per hour determined, the only metrics left to figure out are how often the product will be used and for how long it will need continuous power. With these metric values determined, the total energy per independent battery bank can be calculated, the total independent battery banks needed can be defined, and the total power output and voltage of the earth magnet alternator or magnetic equivalent alternator to recharge one offline independent battery bank per the offline time frame before it is set to be active again.

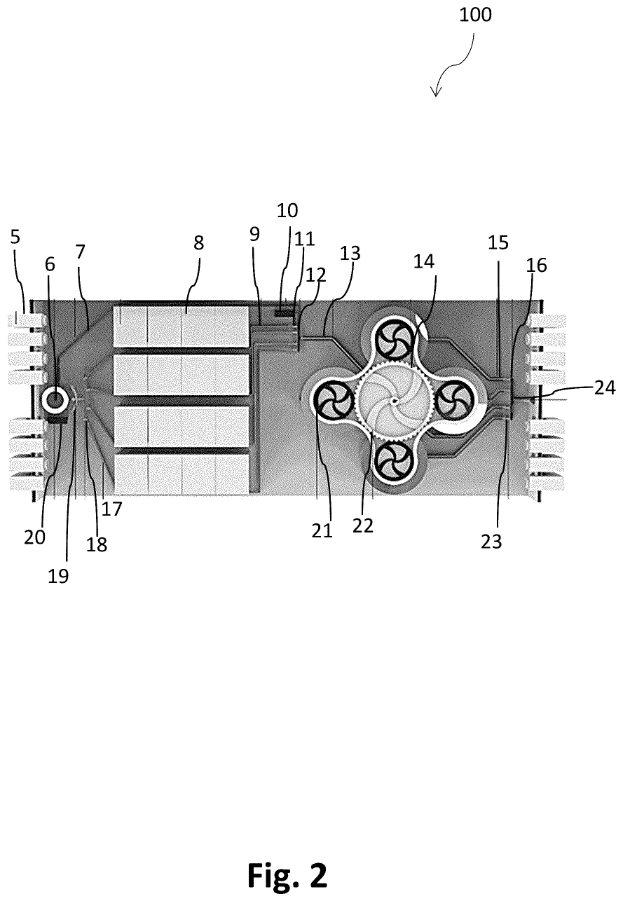

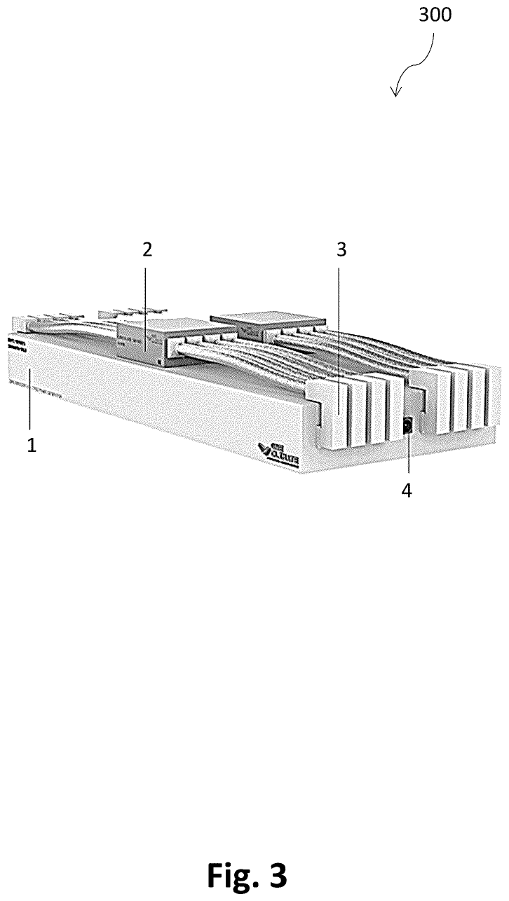

Refer to FIG. 2 which shows an implementation of the system 100 and FIG. 3 which shows a cooling unit 300 of the system 100. System 100 includes an air out venting with electronic butterfly and/or weighted butterfly valves 5, Earth magnet and/or alternative magnetic alternator 6, Earth magnet and/or alternative magnetic alternator power line 7, First battery set 8, Second battery set 9, CPU 10, Male power engager with planetary gear 11, Online battery bank power block 12, Main power line to the alternator drive motor 13, Gear oil pan 14, Main power line 15, Main power block 16, Battery bank recharging power line 17, Female power port 18, Multi-gear switching mechanism assembly 19, Voltage line conditioner 20, Earth magnet alternator planetary gear assembly 21, Sun gear motor assembly 22, Male power engager with planetary gear without a laser 23, Main power line 24.

This system comprises several components, each with its unique function. Shield 1 is a 5-layer IR blocking and vacuum unit that helps to maintain an optimal temperature for part performance and longevity. It also acts as a soundproofing element, ensuring that the generator unit operates without creating any audible noise. The refrigeration unit 2 works in tandem with Shield 1 to regulate the temperature of the containment area. Air return venting 3, equipped with an electronic butterfly and/or weighted butterfly valve, creates airflow and can be shut off in case of a fire, ensuring safety. The air out venting 5, with an electronic and/or weighted butterfly valve, works in conjunction with air return 3, aiding the refrigeration unit 2 in removing all oxygen from the containment area and making it safer in a fire. The AC or DC power out plug 4 is where the AC or DC power can be transported for end use. Earth magnet and/or alternative magnetic alternator assembly 6 generates electricity to recharge each offline independent battery bank 8 in a set time, creating closed loop continuous electrical power rotation. The earth magnet and/or alternative magnetic motor power line 7 connects to the online battery bank power distributor 12, allowing the alternator assembly's motor 6 to draw its power from the online independent battery bank 8. An online independent battery bank ensures efficient operation, with a voltage and amperage metric equal to the operational metric of time it takes to power an individual electric device. The assembly 6 replenishes this operation time at a metric faster than the electrical power used by said electrical device, creating a continuous closed-loop zero-emission electric power supply. voltage line conditioner 20 boosts the speed of the earth magnet and/or alternative magnetic alternator assembly 6, ensuring the same power output for 30 years. The multi-gear switching mechanism 19, critical in directing closed-loop zero-emission power to specific areas at specific times, is adaptable to various models. The form and parts of this mechanism may vary depending on the available space for the product you will power. The battery bank recharging power line 17, connects to each battery bank, while main power in line 9 that connects to male power engager 11 with planetary gear. The online power distributor for rotational power for the main drive motor 12, and the operational CPU 10 that controls all programmed features based on the model and final use. It is worth noting that the programmed features for a car would differ from an outdoor cooler, for instance. The leading power line powers 13 and sun gear motor assembly 22, and the gear configuration will always differ based on the operational gear design. The gear oil pan 14 keeps the gears lubricated within its sealed area. The sun gear motor assembly 22 drives Earth magnet alternator planetary gear assemblies 21, creating either closed-loop zero-emission AC or DC electrical current. The main power line 23 connects the male power engager with a planetary gear unit 15 in, which engages and disengages the main power distributor 16. Finally, the main power line 24 connects to an AC or DC power-out plug 4.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for generating clean energy, the system comprising:
one or more alternators for generating electricity;
a motor for driving the one or more alternators;
a first battery set;
a second battery set, wherein each of the first battery set and the second battery set are configured to power the motor; and
a switching unit configured to switch each of the first battery set and the second battery set between an active state and an offline state, the respective battery set in the active state powers the motor, and the respective battery set in the offline state is charged by the switching unit using electricity generated from the one or more alternators.

2. The system of claim 1, wherein the switching unit comprises planetary gears configured for switching between the two battery sets.

3. The system of claim 2, wherein the switching unit is configured to engage a negative contact first, and then a positive contact for switching the respective battery set to the active state from the offline state.

4. The system of claim 3, wherein the switching unit is configured to disengage a positive contact first and then a negative contact for switching the respective battery set to the offline state from the active state.

5. The system of claim 4, wherein the one or more alternators comprise earth magnet frameless alternators.

6. The system of claim 1, wherein the system further comprises a cooling unit, the cooling unit comprises:
a shield for blocking heat and sound.

7. The system of claim 6, wherein the cooling unit further comprises:
a refrigeration unit for maintaining an optimum interior temperature of the system.

8. The system of claim 1, wherein the system further comprises:
a controller configured to condition an output current from the one or more alternators, and
distribute the conditioned current to a load and the switching unit for charging the respective battery set.

9. The system of claim 8, wherein the system further comprises:
a voltage line regulator for stepping up a voltage.

10. A method for generating clean energy, the method comprising:
providing one or more alternators for generating electricity;
driving the one or more alternators by a motor;
powering the motor alternatively by a first battery set and a second battery set, wherein each of the first battery set and the second battery set are configured to power the motor;
switching, by a switching unit, the first battery set to an active state, and the second battery set to an offline state, wherein the battery set in the active state powers the motor and the battery set in the offline state is charged and does not power the motor;
determining a charge status of each of the first battery set and the second battery set; and
upon determining the charge status, switching the first battery set to the offline state and the second battery set to the active state.
